(19) United States
(12) Patent Application Publication
(10) Pub. No.: US 2008/0052224 A1
(43) Pub. Date: Feb. 28, 2008

(54) METHOD FOR GUARANTEEING A PEER-TO-PEER LOAN

(75) Inventor: Kwame Parker, Brooklyn, NY (US)

Correspondence Address: DARBY & DARBY P.C., P.O. BOX 770, Church Street Station, New York, NY, 10008-0770, US

(73) Assignee: PeerFunds, Inc., New York, NY (US)

(21) Appl. No.: 11/466,936

(22) Filed: Aug. 24, 2006

(51) Int. Cl. G06Q 40/00

(52) U.S. Cl. 705/38

(57) ABSTRACT

Guaranteed peer-to-peer lending in which loan payments between a borrower and a lender include an allocation to an account of a guarantor includes in one aspect a selection of borrower classes including a guaranteed class made available by a server to a first client machine. The server receives from lenders at respective first clients machines respective lender-parameters and respective selected borrower-classes. In the event that the selected borrower-class is the guaranteed class, the allocation of a portion of any loan payments to the collateral account of the guarantor is made automatically. In another aspect, offers are transmitted to lenders concerning a guarantee of any loan that satisfies the lender's parameters in exchange for a guarantor premium, which premium comprises a portion of any loan payments otherwise due to or collected by the lender for credit in to a collateral account of a guarantor.

### FIELD OF INVENTION

The present invention relates to improvements in facilitating the execution of peer-to-peer loans via electronic networks.

### BACKGROUND OF THE INVENTION

Two major problems exist in the current loan system. Unsecured loans are not widely available to consumers, and when they are available, they are typically only for small amounts. Part of the reason is that unsecured loans are disfavored by financial institutions because they are not as easy to sell to major investors as are loans secured by property. A somewhat related problem is that smaller investors cannot take advantage of the lucrative business of investing in loans.

The present invention addresses these problems by offering a pragmatic system and methodology for pairing investors who want to loan money (hereinafter referred to as “lenders”) and borrowers who want unsecured loans.

The present invention also addresses the risk of default associated with unsecured loans by enabling lenders to be paired with guarantors such that the unsecured loan can be insured against default. This encourages investors who may not normally be willing to take the risk of loaning money without collateral to make these unsecured loans to borrowers.

Several advantages flow from this to both borrowers and lenders as described in the tables below.

TABLE 1
Borrower Options and Advantages/Disadvantages

| Loan Type | Advantages | Disadvantages |
|---|---|---|
| Peer-to-Peer | Low borrowing rates | Inability to pay credit-card |
| borrowing | Rapid online application | style “minimum” payments; |
| | process based primarily on | loans are amortizing |
| | credit score or other credit | (mortgage style) |
| | rating system | |
| | Ability to have an unlimited | |
| | number of lenders compete for | |
| | Borrowers business | |
| | No restrictions on size and tenor of | |
| | loan | |
| | Low fees | |
| Unsecured | Relatively rapid application | High average loan rates, e.g., |
| Loan | process based primarily on | for a three-year, $5000 |
| | credit score | unsecured loan |
| | | General limits on loan |
| | | amounts (many institutions |
| | | will not lend more than $5000) |
| | | Product not heavily marketed |
| | | by banks because of relatively |
| | | low fees vs. other loan |
| | | products (credit cards, home- |
| | | based lending) |
| | | Excessive late fees and related |
| | | charges |
| Credit Card | Rapid application process | Average loan rates for |
| | based primarily on borrowers credit | “platinum” cards 12%; rates |
| | score | for lesser cards up to 25% for |
| | Revolving credit means (i) | lower-credit borrowers |
| | funds available at any time up | Option to pay minimum |
| | to limit and (ii) ability to make | payment can result in fiscal |
| | minimum payments without | mismanagement (i.e. |
| | having to pay interest | ballooning debt that can take |
| | Ability to use in thousands of | years to pay off) |
| | worldwide point-of-sale | |
| | locations | |
| Auto Loan | Rates currently in the 6.28% | Generally can be applied only |
| | to 7.26% range for good | to vehicles under 5 years of |
| | credits | age |
| | | Secured by the automobile |
| Cash-out | Attractive rates; average | Extensive and time-consuming |
| Refinancing or | 5.78% for 30 - year fixed-rate | process (2 weeks–2 months) |
| HEL/HELOC | mortgage and 5.51% for a 5/1 | Excessive processing fees |
| | ARM; average 6.65%–6.86% | (legal, title, tax, origination) |
| | for a HELOC and | Extensive documentation |
| | 7.64%–7.85% for an HEL | requirements |
| | | Home is placed directly at risk |

TABLE 2
Lending/Investment Options and Advantages/Disadvantages

| Invest- | | |
|---|---|---|
| ment | | |
| Type | Advantages | Disadvantages |
| Peer-to- | High lending rates compared | Unsecured lending; lender has |
| Peer | to most fixed-income | no direct recourse to |
| lending | investment options | borrower's assets |
| | Ability to specify rate, tenor, | |
| | and borrower risk profile | |
| | Ability to trade in and out of | |
| | investments at any point | |
| | Ability to insure investment | |
| | Low fees | |
| Money- | Liquid securities with very | Low rates (average yield |
| Market | low risk | 3.2%–3.8%) |
| Account | | Not insured |
| Certificate | FDIC insured (i.e. no risk) | Low rates (average 12-month |
| of Deposit | securities up to the first | CD yield at 4.3%) |
| | $100,000 investment | Illiquid; investors must hold |
| | | the security for period of time |
| | | specified at purchase (typical |
| | | tenor 6 months–1 year) |
| Invest- | Medium risk investment; can | Average rates in the 4.5% to |
| ment- | also be purchased in a mutual | 6% range not very attractive |
| Grade | fund to reduce risk | Transaction costs (single- |
| Bonds | | company bonds) or mutual |
| | | fund fees can be excessive |
| High- | Very attractive rates on par | High-risk investment |
| Yield | with Peer-to-Peer lending; | including investment in |
| Bonds | rates in the 7% to 11% range | emerging market economies |
| | | Transaction costs (single- |
| | | company bonds) or mutual |
| | | fund fees can be excessive |

Based on the advantages and disadvantages traditionally available to the borrower and lender listed in Table 1 and Table 2, conventionally made peer-to-peer loans can be an attractive alternative for borrowers. However, such conventional loans have not necessarily been as attractive for lenders because one of the disadvantages is a serious one: the lender has no recourse if the borrower defaults.

The present invention addresses this problem by providing the lender the peer-to-peer transaction with an opportunity to insure the loan by purchasing a guaranty from a guarantor. Under this methodology, the loan facilitator can accept offers from guarantors to receive a percentage of the principal (referred to as premium) in exchange for guaranteeing a peer-to-peer loan, arranged by a loan facilitator between a borrower and a lender. This new method of providing peer-to-peer loans with guaranties can remove the lender's principal concern regarding investments in peer-to-peer loans. With the high risk removed for lenders, peer-to-peer loans of the present invention provide borrowers with an excellent opportunity to borrow money without security and lenders the opportunity to earn a higher return on investment with reduced risk.

### SUMMARY OF THE INVENTION

In accordance with one aspect of the invention, a method for managing loan payments in peer-to-peer lending environment between a borrower and a lender provides a guarantee to the lender. In accordance with this method, a server provides to a first client machine a selection of borrower classes including a guaranteed class. The server receives from lenders at respective first client machines respective lender-parameters and respective selected borrower-classes. The lender-parameters include, among other possibilities, an amount to lend, a term, and a lender-rate. In the event that the selected borrower-class is the guaranteed class, the method automatically allocates a portion of the loan payments to a collateral account of a guarantor. The method is preferably implemented programmatically under control of software operating on the server.

In accordance with another aspect of the invention, a method for managing loan payments in peer-to-peer lending environment between a borrower and a lender introduces a guarantee offer to the lender. In accordance with this method, a server such as the server noted above provides to a first client machine a selection of borrower classes. The server receives from lenders at respective first client machines respective lender-parameters and respective selected borrower-classes. The lender-parameters include the parameters noted above. An offer is transmitted to the lender at a particular first client machine to guarantee any loan satisfying the lender parameters in exchange for a guarantor premium. In the event that the lender accepts the offer, the method automatically allocates a portion of any loan payments to a collateral account of a guarantor.

In accordance with yet another aspect of the invention, a method for a lender to establish a loan comprises the steps of accessing from a client machine a web site hosted by a server, providing lending terms from the client machine to the server, the lending terms including an interest rate and a minimum credit rating, and funding a lender account with a dollar amount. Before funding any loan using money in the lender account, the method of this aspect of the invention includes the additional steps of reviewing at the client machine a third-party offer made available through the web site which offers to guarantee any loan satisfying the lending terms, and committing to pay a premium to the third-party in order to guarantee the loan. After funding the loan, at least one loan payment is received in the lender account.

In accordance with still another aspect of the invention, a method for a guarantor to secure a loan comprises the steps of accessing from a client machine a web site hosted by a server and submitting guaranty terms from the client machine to the server, wherein the guaranty terms include a premium and a minimum credit rating. Before guaranteeing any loan using money in a collateral account, the method of this aspect of the invention includes the additional steps of examining at the client machine a required collateral to guarantee any loan satisfying the guaranty terms, posting the required collateral to a collateral account; agreeing to receive a premium from a third-party in order to guarantee the loan. After guaranteeing the loan, a guaranty premium is received as payment in the collateral account.

These and other aspects, features and advantages can be combined together and further appreciated from the accompanying description of the illustrative embodiments and drawing figures thereof.

### BRIEF DESCRIPTION OF THE DRAWING FIGURES

FIG. 1 illustrates an overview of the process of facilitating and servicing a guaranteed peer-to-peer loan according to one embodiment of the present invention.

FIG. 2 illustrates an overview of another embodiment of the present invention for facilitating a guaranteed peer-to-peer loan transaction.

FIG. 3 depicts components of an exemplary environment in which processes embodying the invention can be implemented.

FIG. 4 illustrates a flow chart demonstrating a portion of the operation of an embodiment of the present invention from a loan facilitator's perspective.

FIG. 4A continues the process flow of FIG. 4.

FIG. 5 illustrates a flow chart demonstrating an embodiment of the present invention from a guarantor's perspective.

FIG. 6 illustrates a flow chart demonstrating an embodiment of the present invention from a lender's perspective.

### DETAILED DESCRIPTION OF THE ILLUSTRATIVE EMBODIMENTS

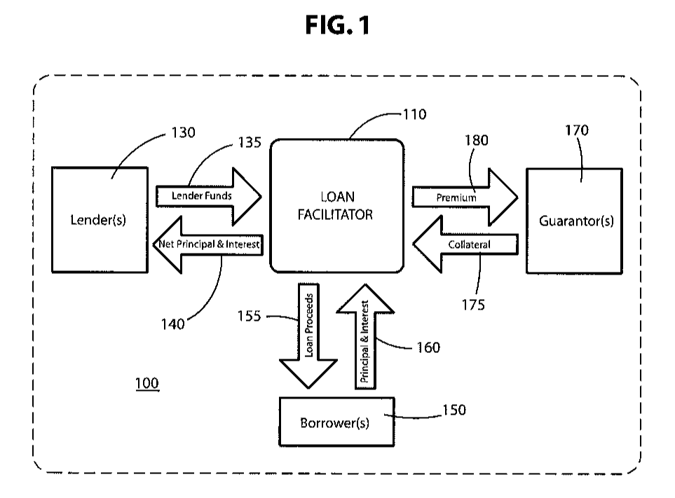

Referring now to FIG. 1, the loan facilitation system 100 consists of at least one loan facilitator 110, at least one lender 130, at least one borrower 150, and preferably at least one guarantor 170. Each of these parties can be a natural person, sole proprietorship, corporation, partnership, trust, or any other business entity.

The loan facilitator 110 generally refers to a company or person that operates a computerized system that performs the methods disclosed and claimed herein. The loan facilitator's 110 main role is to bring together investors, borrowers, and guarantors and does not generally have any direct role in the transactions other than collecting a facilitator fee. Although the loan facilitator 110 does not generally participate in the transactions, the loan facilitator can provide mirror loans (discussed below) or participate in a loan transaction as one of the parties. In certain situations, some processes can be performed manually by humans without directly involving the loan facilitator's 110 computerized system. As used herein, the term loan facilitator 110 is intended to include the loan facilitation company or person as well as the computerized system and the processes that execute therein as well as any manual processes performed without direct computerized assistance.

The borrower 150 is any party seeking to borrow funds.

The lender 130 encompasses typical lenders such as banks, credit unions, and other financial and lending institutions and also includes any investor who prefers to invest money in peer-to-peer loans in order to earn a higher return or for any other business purpose such as diversification.

A guarantor 170 is an investor interested in guaranteeing that a borrower will not default on his obligation. The guarantor 170 agrees to guarantee the borrower's loan for a percentage of the interest paid on the loan. This portion of the interest is referred to as “guaranty premium” In order to become a guarantor 170, an investor provides detailed financial information to the facilitator and obtains approval to provide loan guaranties within the system. If desired, a party can act as a lender 130 for some loans and a guarantor 170 for others. In such a case, the lender 130 would have to meet all the financial requirements that a guarantor 170 is required to meet.

By way of overview, once loan and guaranty terms are agreed upon between the parties (not shown), the loan facilitator 110 transfers lender funds 135 from the lender 130. If a guaranty was requested by the lender 130, the loan facilitator will not transfer lender funds 135 to the borrower 150 until the lender funds 135 and collateral 175 are received. Once the loan facilitator 110 has control of the lender funds 135 and the collateral 175 for an optional guaranty, the loan facilitator 110 transfers the loan proceeds 155 to the borrower 150. The loan proceeds 155 can be the full amount of the lender funds 135 or the loan facilitator 110 can optionally charge a fee to the lender 130 or borrower 150 to proceed on the basis of less than the full loan obligation being transferred to the loan facilitator. The loan facilitator 110 can store excess lender funds 135 for use in a subsequent loan transaction.

After the loan proceeds 155 are distributed, the loan is serviced by the loan facilitator 110. This can be done by collecting a single lump sum repayment, or preferably by periodic payments. The payment(s) preferably are made directly from the borrower's bank account. There is no set requirement for how the funds are repaid. This is left solely to the discretion of the lender 130, the borrower 150, and the guarantor 170 to reach a suitable agreement via communications exchanged through the loan facilitator 110.

In paying down the loan, the borrower 150 pays a lump sum payment including interest or periodic principal & interest 160 to the loan facilitator 110. The loan facilitator can keep a portion of this principal & interest 160 as a fee for facilitating the loan or can distribute all of the principal & interest 160 to the lenders 130 and/or guarantors 170. The portion actually distributed to the lender is referred to as the “net principal & interest” 140. If the lender 130 requested a guaranty for the loan, the guarantor will receive the agreed upon premium 180 from the principal & interest 160 before the loan facilitator 110 pays the net principal & interest 140 to the lender 130.

The above description is for exemplary and introductory purposes. The order of the operations is not important as long as they are commercially reasonable. For example, it does not matter if the premium 180 is paid to the guarantor 170 before the net principal & interest 140 is paid to the lender 130 so long as whatever methods used are agreed upon by the parties and are commercially reasonable, e.g., it is not likely commercially reasonable to distribute the loan proceeds 155 prior to receiving the collateral 175 on a guaranteed loan transaction. Another example of how the method described above can be slightly modified without affecting the result is by having the lender 130 transfer the lender funds 135 to the loan facilitator 110. This is the same basic methodology as described above except the loan facilitator 110 does not “pull” the lender funds 135 from the lender 130 but the lender 130 “pushes” the lender funds 135 to the loan facilitator 110.

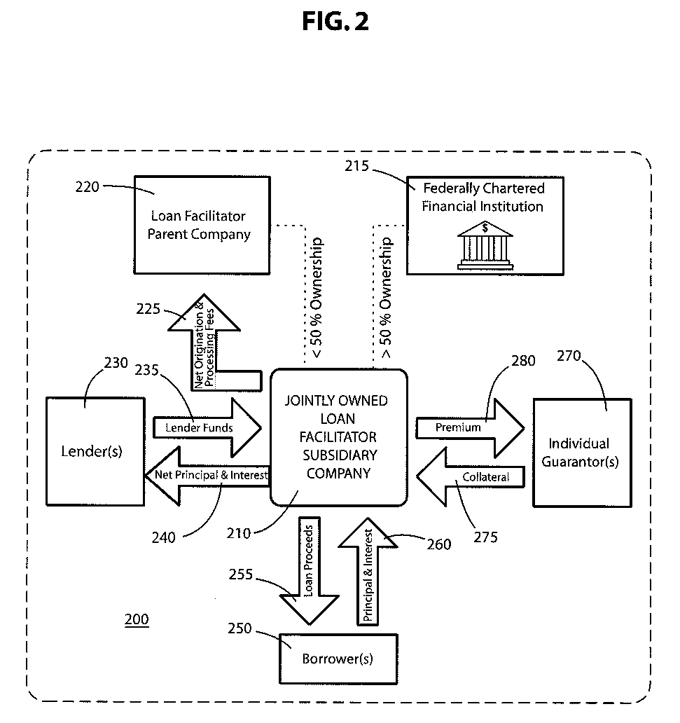

Referring now to FIG. 2, another embodiment of the loan facilitation system is disclosed. Lender 230, borrower 250, and guarantor 270 have the same roles as described above with respect to FIG. 1. The loan facilitator takes on a slightly different role in this embodiment. The loan facilitator is now a jointly owned loan facilitator subsidiary company 210. The loan facilitator subsidiary 210 is jointly owned by the loan facilitator parent company 220 and a federally chartered financial institution 215. In this embodiment, the federally chartered financial institution 215 owns a majority interest (i.e., at least 50.1%) in the loan facilitator subsidiary 210.

The ownership by a federally chartered financial institution 215 provides regulatory advantages. In the United States, each state generally has its own unique laws regarding lending money, allowable interest rates, etc. while federally chartered financial institutions are subject to unified federal regulations that trump the varying state regulations. By vesting majority ownership of the loan facilitator subsidiary in a federally chartered financial institution 215, the loan facilitator subsidiary 210 can facilitate loans to all parties (from different states) using identical regulations. In order to gain the regulatory advantage, it may be necessary for the loan facilitator subsidiary to make the loans to the borrower because it is classified as a federally chartered financial institution. To make this function while maintaining the peer-to-peer loan model, the lender can make a loan to the loan facilitator and the loan facilitator can immediately make a mirror loan based on the same terms to the borrower. This process can be mostly transparent to the borrowers 250, lenders 230, and guarantors 270. This achieves the same basic results as a peer-to-peer loan while gaining regulatory advantages. Obtaining these regulatory advantages can allow the loan facilitator subsidiary to have much lower startup and operation costs due to lower regulatory compliance expenditures, notwithstanding the tiered loan facilitator corporate structure.

In FIG. 2, the lender funds 235, the net principal and interest 240, the loan proceeds 255, the principal & interest 260, the collateral 275, and the premium 280 all function the same as in the embodiment of FIG. 1. However, the embodiment shown in FIG. 2 also depicts the loan facilitator subsidiary transferring the net origination & processing fees 225 from the loan facilitator subsidiary 225 to the loan facilitator parent company 220. The federally chartered financial institution 215 may or may not receive a share of these proceeds in addition to its receipt of income from the storage of funds for lenders 230 and guarantors 270 when the funds are not being utilized as part of a transaction.

The above description of FIG. 2 is for exemplary and overview purposes. Many modifications can be made to the system shown in FIG. 2 without departing from the invention. For example, the ownership of the loan facilitator parent company 220 can be divided among many entities. The ownership of the federally chartered financial institution 215 can be divided among multiple entities as long as they are federally chartered financial institutions. The net origination & processing fees can be paid to the federally chartered financial institution 215 or not collected at all. FIG. 2 is not intended to be all inclusive and depict every possibility. FIG. 2 is only intended to provide an exemplary framework for one embodiment of the inventive method.

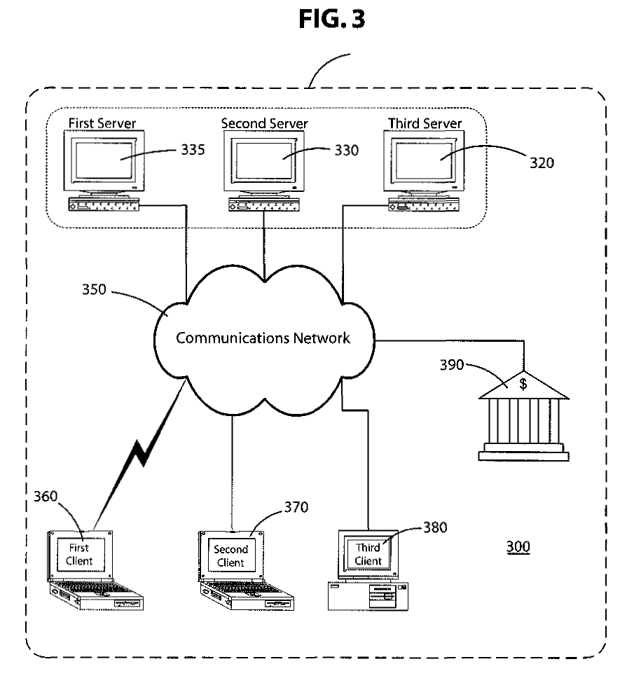

Referring now to FIG. 3, the required components for implementing the inventive method over a communications network 350 such as the Internet are shown. Three servers 320, 330, and 335 can be utilized to allow borrowers, lenders, and guarantors to access different web sites from respective clients 360, 370, 380. Also connected through communications network 350 is a bank 390. This depiction is for exemplary purposes. In actuality, there can be many more (or less) servers and clients involved in the system. There can also be additional banks. For example, there can be a single server operating a borrower web site, a lender web site, and a guarantor web site simultaneously. The individual web sites can also be combined into a single web site. Furthermore, the borrowers, lenders, and guarantors can access the multiple servers or a single server from a single client installed at a financial institution or the like. There is no set system configuration requirement and the method can be executed in many different ways using conventional software and client/server architecture. The clients and server are shown to demonstrate one possible architecture of the web servers and the client computers that can access them.

Other modifications to this diagram include the addition of multiple banks for the transfer of funds from and amongst the borrower, lender, and guarantor. Additionally, the bank 390 can be some other form of financial institution such as a brokerage house, credit union, savings & loan institution, or a service such as PayPal®, Cybercash® or some other electronic fund transfer system. Additionally, while the first client 360 and second client 370 are depicted as laptop computers, any type of device capable of interfacing with a web or database server can be utilized. For example, a PDA or mobile telephone can be used to directly interface with a web server. The system can also have an automated interface accessible via telephone or mobile phone. Any type of conventional interface to a web, message, or database server can be utilized. It is also feasible for the information to be accepted via operator assisted telephone call or facsimile.

The communication link between the client machines and the server is also flexible. A typical hard wired network connection is depicted for the servers 320, 330, and 335; a wireless network connection is depicted for first client 360; and a hard wired network connection is depicted for clients 370 and 380. Any conventional means for connecting clients to servers can be utilized including wireless data via mobile phones, satellite uplinks, direct cable connections via serial cables, VPN connections, and the like, as such connectivity is not part of the present invention.

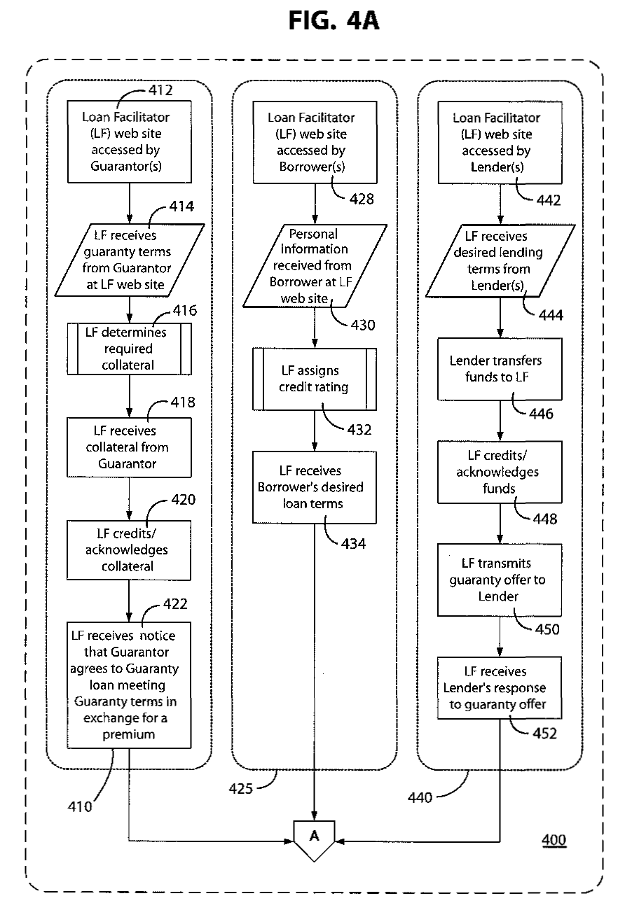

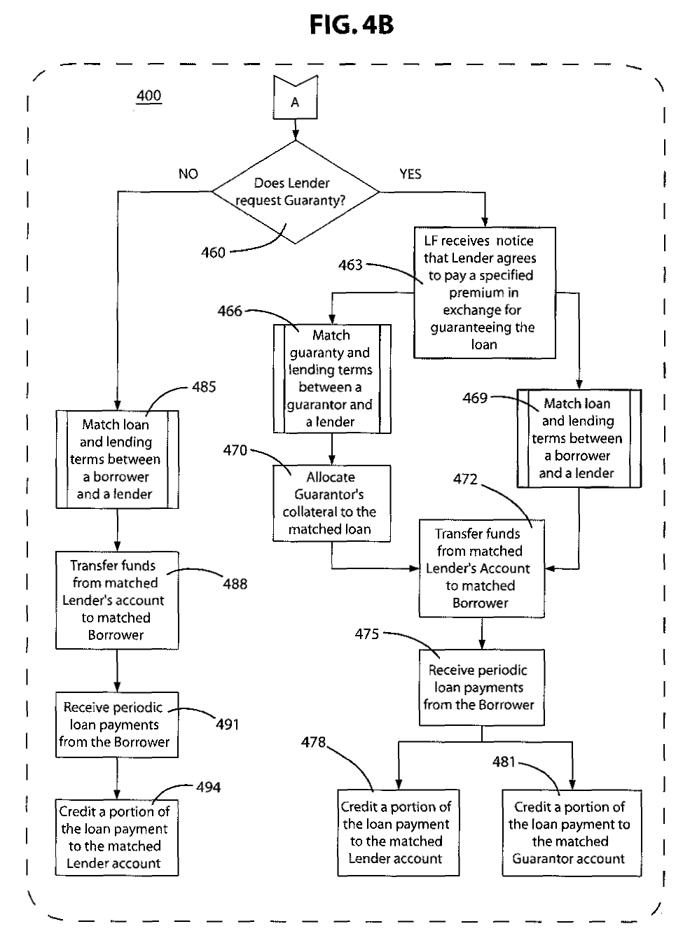

Referring now to FIGS. 4A and 4B, the flow chart provides a detailed description of the processes taking place at the loan facilitator. The flow chart assumes all processes are performed online or in some other electronic format. This assumption is for simplification only and should not be construed as limiting the invention. Many processes can take place offline or via a paper transaction as necessary. Some processes can be simplified in this manner due to required human intervention (such as the approval of guarantors).

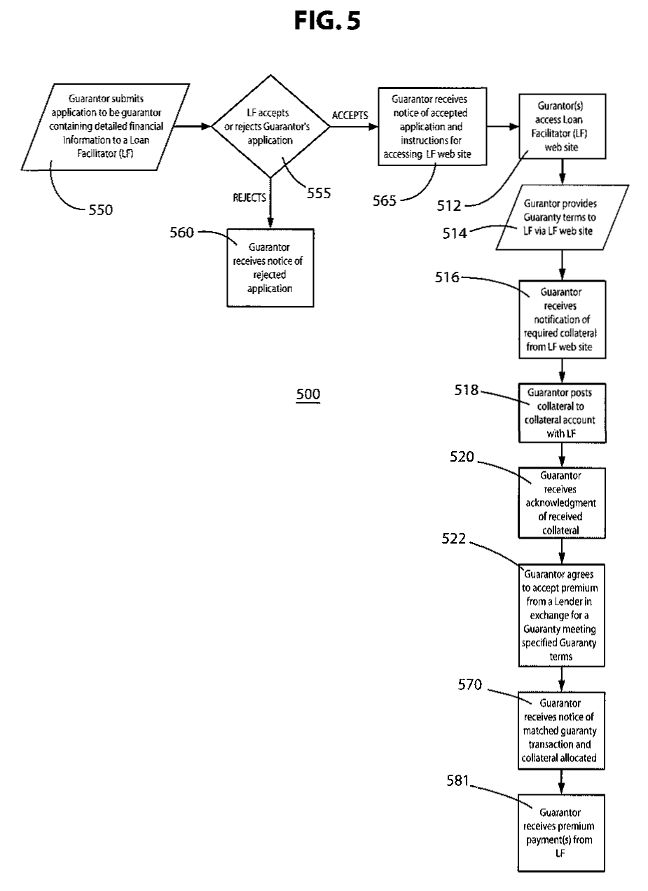

The guarantor process 410, the borrower process 425, and the lender process 440 can all take place in parallel. This is not a requirement, but the processes are essentially independent of each other and can occur simultaneously, though this is not required. FIG. 4 depicts the system operation once all parties are approved. Note that additional steps are required for guarantors to be approved to guarantee loans and are depicted and discussed in FIG. 5.

The guarantor process 410 consists of multiple steps for the loan facilitator to receive all necessary information for facilitating a guaranty transaction if requested by a lender. At step 412, the loan facilitator web site is accessed by the guarantor. The loan facilitator receives specified guaranty terms from the guarantor at the loan facilitator web site at step 414. There are no specific required guaranty terms. The only requirement is that the terms received by the loan facilitator be sufficient for the loan facilitator to match and execute a guaranty transaction between a guarantor and a lender. Some guaranty terms that can generally be utilized include, but are not limited to, guaranty amount, premium, minimum credit rating, length of guaranty. The premium is the amount of the loan (usually expressed in a percentage of the principal, similar to interest) that the guarantor is willing to accept to guarantee a loan based on the specified terms. The minimum credit rating is the minimum credit rating the guarantor is willing to guarantee a loan for. It is common for the guarantor to enter several combinations of guaranty terms. For example, for a borrower with an excellent credit rating, the guarantor may be willing to accept a lower premium and can enter guaranty terms such as “premium=0.5% for a credit rating of AA” and “premium=3.0% for a credit rating of D.” The guarantor can enter as many combinations of guaranty terms as desired and can even prioritize which particular guaranty terms are preferable such that the more preferred guaranty terms are matched before the less preferred guaranty terms. This can be important to guarantors so their money can be invested in higher risk, higher return guaranties first if desired.

Once the loan facilitator receives the guaranty terms, the loan facilitator determines how much collateral the guarantor must post with the loan facilitator in order to guarantee loans based on the entered guaranty terms at step 416. The collateral can be determined by any means agreed upon between the guarantor and loan facilitator. One example of such process is for the loan facilitator to review the guarantor's financial condition and based on the financial stability of the guarantor, require a percentage of the amount he is willing to guarantee be posted to a collateral account with the loan facilitator. This is only one example of how collateral may be determined and should not be construed as the only formula. Any conventional method of determining collateral can be used in the invention.

Once the loan facilitator determines the required collateral at step 416, the guarantor can determine whether he is willing to post the collateral and if so, the guarantor posts the collateral and the loan facilitator receives the collateral at step 418. Once the loan facilitator receives the collateral, the collateral is generally credited to the collateral account and an acknowledgement or confirmation can be transmitted to the guarantor via a standard communication method at step 420. Such transmission can be by any typical method including, but not limited to, electronic mail, visual display on a web page, regular mail, facsimile, telephone call, or the like.

At some point during the guarantor process 410, the guarantor makes a binding commitment to guarantee loans meeting specified guaranty terms. This is depicted at step 422 in FIG. 4A. This can be an implicit acceptance that occurs earlier or later in the process depending on the exact configuration. It is not important when this occurs but this binding commitment generally occurs at some point before the loan facilitator can offer guaranty terms to a lender and execute a guaranty transaction between a matched lender and guarantor.

In parallel to the steps of the guarantor process, the borrower process 425 can occur. The borrower process is much simpler because the borrower is typically not involved with the guarantor because it is traditional for the lender to purchase a guaranty for a loan in the loan industry. A guaranty can be offered to a borrower if this custom were to change or the market demanded it without departing from the scope of the invention, but FIG. 4 is directed to circumstances where the lender purchases the guaranty, not the borrower. Because of this, the borrower process 425 is relatively straightforward. The borrower accesses the loan facilitator web site to request a loan at step 428. As discussed above, any known means of requesting a loan can be utilized such as paper applications, telephone applications, etc. As long as the loan facilitator receives the relevant data regarding the loan request, it is not important how the data was received. Once the loan facilitator receives the borrower's personal information at step 430, the loan facilitator runs a credit check and assigns the borrower a credit rating at step 432. Now that the buyer's credit rating is determined, the loan facilitator can inform the borrower what rates are typical for someone of his credit rating to facilitate the borrower entering his desired loan terms and the loan facilitator receiving these terms at step 434.

The type of personal information required of the borrower can vary. Typically a social security number is sufficient to run a credit check, however, the personal information referred to herein is not so limited. The loan facilitator typically has wide latitude in requesting as much information as desired by lenders and guarantors. Such information includes, but is not limited to, social security number, pay check stubs, utility bills, tax returns, financial documents, and the like. This type of personal information is commonly requested in loan transactions and one of ordinary skill in the art can recognize the many types of information that may be requested to enter into a loan transaction.

The type of credit rating utilized is similarly flexible. Currently, the most common standardized credit rating system is a FICO (First Isaac & Co.) credit score with a range of 340-850. FICO credit scores are known in the art and do not require further description herein. Sometimes credit scores are divided into classes based on the credit score such as AA, A, B, C, D, etc. with each having a specified credit score rating or range. Any type of credit rating system that is considered acceptable to the lenders and guarantors having to evaluate borrowers can be utilized.

The lender process 440 executes roughly in parallel with the guarantor process 410 and the borrower process 425. However, as with the previous processes, there is no requirement that the process execute directly in parallel. The lender process includes the necessary steps for a lender to prepare to provide a loan to a borrower if the terms are matched. Initially a lender accesses the loan facilitator web site at 442. The lender enters desired lending terms and the loan facilitator receives the lending terms at step 444. Lending terms can include any terms desirable by a particular loan facilitator and/or lender. Some examples include minimum interest rate and minimum credit rating. As with the guaranty terms discussed above, there will likely be multiple sets of lending terms at different rates because a lender will be willing to loan lower risk credit classes money at lower interest rates. For example, for a borrower with an excellent credit rating, the guarantor will likely be willing to accept a lower interest rate and can enter lending terms such as “minimum interest rate=7% for a credit rating of AA” and “minimum interest rate=21.0% for a credit rating of D”. The lender can enter as many lending terms as desired and can prioritize particular lending terms such that a more preferred lending term is matched before a less preferred lending term.

The loan facilitator preferably receives funds from the lender prior to executing a loan transaction at step 446. Optionally, a margin account can be established between the loan facilitator and the lender, but the examples herein assume the loan facilitator receives funds from the lender prior to funding of the loan. The funds receipt can occur at any time during the process, but preferably occurs prior to the transfer of funds to the borrower. In FIG. 4, the funds are received from the lender after the lending terms have been received from the lender. This is for exemplary purposes only and the lender process 440 does not have to occur in this order. Thus, the loan facilitator may not truly receive the funds from the lender but can act as an intermediary to transfer the funds from the lender directly to the borrower (and possibly retain a portion of the funds as a fee). Regardless of how the funds transfer takes place, the loan facilitator typically confirms the funds transfer to the lender at step 448. This can be through an entry on an account statement, a formal notification, or the like.

The lender process 440 also includes the loan facilitator transmitting a guaranty offer to the lender at step 450. This can consist of a mailing, an email, a pop-up box on the web site, a screen notification, or the like. The guaranty offer transmitted by the loan facilitator to the lender can take many forms but will typically include at least a guaranty premium for a particular set of lending terms entered by the lender. The guaranty offer at step 450 is not typically a binding offer from the loan facilitator. The offer only notifies the lender that a guaranty may be available and provides typical terms. If the lender wants a guaranty, the lender enters acceptable guaranty terms and the loan facilitator attempts to match the terms. Typically, the guaranty offer will be presented to the lender immediately after the lender enters lending terms, although this is not required. The guaranty offer can include approximate premium that a lender may expect to pay for a given set of lending terms (credit class and amount). If an approximate premium is presented, the lender may end up paying more or less than the presented premium because this is merely an anticipated premium or range of premiums. The loan facilitator presents this premium information for guidance purposes so that the lender can enter its own guaranty premium offer if a guaranty is desired. At step 452, the loan facilitator receives the lender's response to the loan facilitator's guaranty offer.

For example, a loan facilitator offers the lender a guaranty premium after a lending offer is entered for a class D credit loan in an amount up to $20,000.00. The loan facilitator can notify the lender that guaranty offers are available for this loan and display that the guaranty premiums for this type of loan typically range from 2.2 to 4.5%. The lender can then enter guaranty terms stating that he is willing to accept a guaranty at a 1.9% premium. The loan facilitator may or may not be able to find a suitable guarantor that is willing to accept the lower loan premium, but the lender is free to offer any premium he desires in hopes of achieving a match.

Optionally, the above lender process can include the presentation of a special class of borrowers referred to as “Guaranteed” borrowers. From the lender's perspective, this special class of creditors lumps creditors of all credit classes into a class of creditors that will all be guaranteed. This can be a convenient way to present the guarantee offer to the lenders because the lender may not care about the credit class of the borrower if the borrower is backed by a guarantor. This allows the loan facilitator to simplify the matching process by only having to match a guarantor with an appropriate credit class and the lender with the appropriate net interest rate after deducting the guarantee premium. This can make the decision of the lender much simpler because the lender does not have to evaluate separate credit classes and what an acceptable guarantee premium and interest rate would be for the various credit classes.

As an example of implementing this optional special “Guaranteed” credit class, the loan facilitator can provide the lender the option of choosing from borrower credit class A-D or Guaranteed credit class. The lender can then enter the desired interest rate for the particular class chosen. Under this system, the lender has the option to choose a particular credit class (such as credit class C) and then request a guarantee for a specified premium based on the credit class. The lender can also choose the “Guaranteed” class and allow the loan facilitator match any credit class with a suitable guarantee to yield the lenders desired net interest rate without concerning himself with the amount of premium being paid. If the lender chooses the “Guaranteed” credit class, the lender enters his desired “net interest” rate instead of the gross interest rate as entered with a specified credit class. The net interest rate is the interest rate the lender receives after all deductions are made from the interest. These deductions could include a guaranty premium, loan fees, processing fees, or any other fees charged by the guarantors or loan facilitator.

If the loan facilitator chooses to present the optional “Guaranteed” class of creditors to the lenders, the process for a guarantor is no different. The Guarantor still chooses a guaranty premium based on the class of creditor and amount as with a standard loan guaranty. These terms must still be matched between a guarantor and a borrower to yield a matched net interest rate for a Lender before a loan transaction can be executed.

The process of offering a guaranty to a lender has been described in its most commercially viable form based on today's market. In today's market, the lender typically purchases the guaranty. However, as market conditions change, it may become more feasible for the borrower to purchase the guaranty and the lender require a guaranteed loan from borrowers. If this type of system is desired, the inventive method can be modified such that the guaranty terms are presented to the borrower in a similar process as described herein with respect to the lender.

Alternative presentations of the guaranty offer are possible. For example, the loan facilitator can display specific guaranty terms offered by guarantors and immediately execute a guaranty conditional upon matching a loan.

Although the guarantor process 410, the borrower process 425, and the lender process 440 have been described as essentially parallel, there is no specific timing for the overall processes or their individual steps. The loan facilitator web site is continuously accessible for guarantors, lenders, and borrowers to perform one or more of the individual steps at any time. For example, a guarantor or lender can log on to the web site and immediately deposit funds into a guarantor or lender account prior to making any offers such that the funds are ready when a guaranty offer or lending offer is made. Alternatively, the lending terms and guaranty terms can be entered immediately and the funds not made available to the loan facilitator until weeks or months later. One important timing element concerns the occurrence of the offers and making the funds available prior to the actual execution of the loan/guaranty transaction which is preferred so that all parties are financially protected.

After the initial guarantor, lender, and borrower processes have taken place, the loan facilitator can proceed to match borrowers with lenders and, optionally, any guarantors. At step 460, the loan facilitator determines if a guaranty is requested to determine whether a guaranty should be matched to the borrower/lender.

If a guaranty is requested by the lender, the loan facilitator receives notice of the guaranty request at step 463. The loan facilitator then matches a guarantor with a lender at step 466 and a lender with a borrower at step 469. If no guaranty was requested, the loan facilitator will match only a borrower and lender at step 485. Once the matching occurs, the loan is funded by the loan facilitator transferring funds from the loan facilitator to the borrower at step 472 (with guaranty) or step 488 (without guaranty). If a guaranty was also matched at step 466, the guarantor's collateral is allocated by the loan facilitator to guarantee that particular loan at step 470. The allocation of the collateral prevents the guarantor from guaranteeing more loans than available collateral.

Once the loan proceeds are transferred to the borrower, the loan facilitator handles the payback of the loan either through lump sum payments or periodic payments. Assuming for exemplary purposes that the borrower pays the loan back periodically, the loan facilitator collects each loan payment at step 475 (with guaranty) or step 491 (without guaranty) until the agreed number of payments are made. If there is no guaranty, the loan facilitator credits the loan payment to the lender's account after withholding any fees at step 494. If there is a guaranty, the loan facilitator credits the required premium amount to the guarantor's account at step 481 and then the remaining portion of the loan payment to the lender's account after withholding any fees at step 478.

The matching process requires further explanation. Note that any type of matching process can be utilized to achieve terms agreeable to all parties and further optimize the investments of the lenders and guarantors or the borrowing of the borrowers. For exemplary purposes, a basic matching procedure will be described. The matching process can be the same for each type of transaction and will be described so as to be applicable to both types of matching. For exemplary purposes, actual numbers will be used. This example should not be construed as limiting as more complex matching methodologies can be utilized within the scope of the inventive method.

A borrower logs on to the loan facilitator web site and enters his personal information and requests a loan in the amount of $10,000.00 for 3 years. The loan facilitator assigns the borrower a credit rating of C. The loan facilitator notifies the borrower that typical interests rates for this loan would likely be in the 16% to 18% range. The borrower then finalizes the loan request by stating that he will pay a maximum of 16.5% interest. The guarantor logs on to the loan facilitator web site and enters several guaranty offers, including a guaranty offer specifying a class C borrower for up to $30,000 loan amount for up to 5 years at a 2.0% premium. Based on the known financial condition of the guarantor (typically verified prior to providing the guarantor access to the guaranty feature), the loan facilitator requires 8% collateral for such a loan and the guarantor posts $2,400.00 in collateral. A lender also logs on to the loan facilitator web site and enters several lending offers including one specifying up to a $15,000.00 loan for a class C borrower at a minimum rate of 16.25% interest for up to 4 years. This particular lender accepts the loan facilitator's offer to match the lender with a guarantor and the loan facilitator notifies the lender that typical guaranty premium rates are between 1.75% and 3.0%. The lender requests the guaranty and notifies the loan facilitator that he is willing to pay up to 2.25% premium.

Now the matching occurs. The combination of fact as in the foregoing example will match to form a transaction. The lender wants to loan money at 16.25% interest and borrower is willing to pay up to 16.5% interest, so this term is matched at 16.25%. The same lender is willing to loan up to $15,000.00 and the borrower only requests $10,000.00, so this term is matched. The borrower wants to borrow money for 3 years and the lender is willing to loan the money for up to 4 years, so this term is matched. The terms of the loan have all successfully matched for a loan transaction. However, the lender's required guaranty is not yet matched. The guarantor is willing to guarantee up to $30,000.00 for up to 5 years for 2% premium. The lender is willing to pay up to 2.25% premium for the $10,000 loan already matched with a borrower. This meets all the guarantor's requirements and the lender's requirements and thus the guaranty is matched at 2.0% premium. This provides for a successful guaranty match and the loan and guaranty transaction are both executed.

In executing the transaction, the loan facilitator transfers $10,000 of the lender's funds (from a third party account or a loan facilitator account) to the borrower's account (third party or loan facilitator). The loan facilitator need not transfer the full amount to the borrower due to origination and/or processing fees. The loan facilitator also commits $800.00 of the guarantor's collateral (8% of the guaranteed amount).

The borrower's sole request has been filled at this point, however the guarantor and lender still have open offers. The guarantor only guaranteed $10,000 of the $30,000 he is willing to guarantee, so the loan facilitator updates the available guaranty offer to reflect the new amount of $20,000 on the same terms as before. The lender has only loaned $10,000 of the $15,000 he is willing to loan so he now has an updated account reflecting an outstanding $5,000 loan offer on the same terms as before.

As more loans and guaranties are filled, the loan facilitator updates the outstanding offers to reflect the amount of funds/collateral available for the system to use for matching purposes.

If the lender chooses the optional “Guaranteed” credit class, the matching process can be much simpler for the loan facilitator because the lender's selected credit class is no longer an issue as long as the lender's net interest rate is achieved. Other than the removal of the “credit class” term to be matched with the lender, the matching process is essentially the same as described above for a lender-specified credit class.

The above example is a simple one assuming one of each type of party (guarantor, lender, and borrower). However, a preferred system operates in a more complex manner with multiple borrowers, multiple lenders, and multiple guarantors involved in each loan transaction. The system can be optimized to match each party with the best available terms. For example, if two lenders can both match a given borrower but one is willing to accept a lower interest rate, the system can match the borrower with the lowest interest rate available at the time of matching. A similar process can occur for lenders and guarantors. The loan facilitator can match the guarantor with the lender that is willing to pay the highest premium when all other terms match. The loan facilitator can also match a lender with a borrower willing to pay the highest interest rate.

An additional advantage of the invention exists in the dividing of all transaction types into tranches. This is not an essential feature but can limit the risk of default on any particular transaction. For example, the loan request from the borrower above trying to borrow $10,000 can be divided into 10 tranches of $1,000.00 each. The loan facilitator can then match each loan tranche with a different lender such that if the buyer defaults, the loss is divided among multiple lenders. In a similar manner, the lender's lending offers and guarantor's guaranty offers can be divided into tranches. By using tranches, the lender willing to loan $15,000 can loan the $15,000 to 15 (more or less) different borrowers such that if any borrower defaults, only a small portion of the investment will be lost. The guarantor's $30,000 guaranty offer can also be split into multiple tranches to minimize risk of default.

There is no set requirement for the amount of the tranches or even that tranches be utilized. This is an optional feature available to the lenders and guarantors to minimize their exposure to default. Typical borrower default rates demonstrate why it can be beneficial to divide the transactions into tranches. The following data shows what percentage of creditors of various standardized credit classes default on their loans. The data is from a random sampling of credit record accounts taken by a major credit bureau for people with a debt to income ratio of less than 20%. While these percentages may vary somewhat depending on the population sample and credit bureau, the data is useful for exemplary purposes.

TABLE 3
Default % for Various Credit Ratings

| | | Average | |
|---|---|---|---|
| Credit Score | Credit Grade | Default % | Range of Default % |
| 760+ | AA | 0.2 | 0.00–0.40 |
| 720–759 | A | 0.9 | 0.70–1.10 |
| 680–719 | B | 1.8 | 1.60–2.10 |
| 640–679 | C | 3.3 | 2.90–3.70 |
| 600–639 | D | 6.2 | 5.40–7.20 |
| 540–599 | E | 10.4 | 9.10–11.80 |
| Below 539 | HR (High Risk) | 19.10 | 15.10–28.20 |
| No Credit History | NC (No Credit) | No Data | No Data |

For a lender loaning to a class D borrower, it can be expected that about 6% of the borrowers will default on the loan. This affects the interest rate and the interest rate can be determined in view of this default rate and other risk factors. Various formulas for weighing these risks are known in the art. By dividing each loan into many tranches, the lender can reduce the risk associated with this default rate by charging the appropriate interest rate on his tranched portfolio. The more tranches the funds are divided up into, the lower the default risk will be to the lender for any given credit class.

Another advantage of the present inventive method is that providing peer-to-peer loan guaranties encourages the willingness of lenders to loan money to borrowers with lower credit ratings because they can purchase a guaranty. The present inventive method can be utilized to optimize the rate of return for a lender by offering a loan transaction with a borrower having a lower credit class than desired while purchasing a guaranty that can result in a higher net-return on investment. This concept is best illustrated with an example. A lender enters an offer to lend money to a class C creditor at 16% interest. Based on the average default rate of 3.3% for a class C creditor shown in Table 3, the lender calculates this to yield approximately a 12.7% net return on investment. Note that this net return on investment is a simplified estimate. There are many different methods for the lender to estimate what his real net return on investment is, but this method is simple and well-suited for exemplary purposes. The inventive method can utilize any known method of estimating return on investment.

The loan facilitator can review the typical interest rates for borrowers with lower class credit and the typical guaranty rates for such loans to determine if the lender can get a better return on investment. Given the above example, assume that a typical interest rate for a class E creditor is 23%, and a typical guaranty premium for a class E creditor is 8.0%. The loan facilitator can present the option of making a lending offer for this lower class creditor (as compared to a class C creditor, for example) and requesting a guaranty to remove virtually all risk and still make a higher return on investment. For the class E creditor at 23% and paying an 8.0% premium, the lender's estimated net return on investment is 15% (instead of 12.7. %) and this is virtually guaranteed (assuming the guarantor meets all obligations) not to result in a loss to the lender. By making such offers available to the lenders, the loan facilitator can optimize the lender's overall return on investment or just simply reduce the lender's risk.

Yet another advantage that can be achieved using the inventive method involves the automatic recreation of guaranty and lending offers and loan requests up to the maximum amount entered into the system. Such options can be presented on the loan facilitator web site. When lending offers, borrower requests, or guaranty offers are partially filled, the outstanding offers decrease. For example, if a lender is willing to loan up to $20,000.00 and loans for $15,000 are executed, the loan facilitator automatically updates the lender's offer to reflect the new amount of $5,000.00 that the lender is still willing to loan. As an option to the guarantors, lenders, and borrowers, as the loans are repaid and the principal amount outstanding decreases, this reduction in the amount of outstanding loans or guaranties to each party can be credited back to the offer amounts to increase the offers. For example, if the lender above still has a $5,000.00 outstanding loan offer and $2,500 in principal is repaid from outstanding loans, the lender can instruct the loan facilitator to automatically increase his outstanding loan offers back to $7,500.00 because the principal received reduces the outstanding loan amount for that lender to only $12,500. This can be particularly advantageous for guarantors and lenders because the loan facilitator can automatically perform this increase as payments are received for the lenders and guarantors to obtain maximum return on their funds.

Although the request would not likely be as common, borrowers can also request that the loan facilitator add a loan request automatically for the amount of principal repaid with each payment. This allows a borrower who pays back $2,500.00 in principal to immediately have a new loan request of $2,500.00 generated by the loan facilitator.

Referring now to FIG. 5, the inventive method is described from the guarantor's perspective with similar steps to FIGS. 4A and 4B. At step 550, the guarantor submits an application to the loan facilitator to provide loan guaranties. The application can be simple or elaborate depending on many factors including the reputation of the guarantor, the loan facilitator's requirements, the desired guaranty amount, and the like. In the case of an individual guarantor, the loan facilitator can request a credit check, review tax returns, require detailed financial information, and the like. Detailed financial information can include, but is not limited to, detailed credit information and information regarding liquid assets, non-liquid assets, real estate holdings, and any other information relating to a party's financial condition. Once all the necessary application information is supplied to the loan facilitator, the loan facilitator makes a decision regarding the application at step 555, the guarantor either receives notice of a rejected application at step 560 or alternatively, the guarantor receives notice that the application was accepted and instructions for accessing the loan facilitator web site at step 565. These instructions can include an account number, a phone number to activate the account, a user name and password, a pin, or the like. Providing secure access to an account is known in the art and any conventional means can be utilized.

After the guarantor receives instructions for accessing the loan facilitator web site at step 565, the guarantor can complete the guarantor process 510. Note that the steps comprising the guarantor process are not required to occur in any specific order. Any method that allows all of the steps to occur in a commercially reasonable or desirable manner is acceptable. For example, the guarantor can choose to fund the collateral account before entering any guaranty offers.

The steps of the guarantor process 510 are similar to the steps of the guarantor process 410 but are now described from the guarantor's perspective for completeness. At step 512, the guarantor can access the loan facilitator web site. At step 514, the guarantor enters a guaranty offer specifying guaranty terms such as guaranty premium, maximum guaranty amount, maximum guaranty length, and minimum credit class. Based on the entered guaranty offer or offers, the guarantor receives notification of the required collateral for the offers from the loan facilitator at step 516. At step 518, the guarantor can then post the collateral to a collateral account with the loan facilitator or provide account information to an existing account such that the loan facilitator can electronically withdraw the collateral as it is required to execute a guaranty transaction. Once the loan facilitator receives or withdraws the collateral, the guarantor receives notice of such receipt or withdrawal at step 520. As discussed above, there is no set requirement on how the collateral is transferred, accessed, or allocated. There are many known methods for such operations. Any of the known methods can be utilized in conjunction with the inventive method.

Note that the guarantor can enter multiple guaranty offers totaling more than the amount of funds transferred or made available for collateral. For example, the guarantor may enter guaranty offers requiring up to $100,000.00 in collateral but only transfer $20,000.00 to his collateral account. The loan facilitator only matches guaranties up to the amount for which the guarantor has available collateral and thus many offers are never executed because the collateral is not available. [This statement is not correct. If a guarantor is cleared to guarantee up $100K, they might have to post $20K as collateral (depending on minimum guaranteed class, etc.) The guarantor is then able to guarantee up to the full $100K, but only the $20K will have to be posted with PeerFunds as collateral. Please revise.] Alternatively, the guarantor can instruct the loan facilitator to only match guaranties requiring up to $20,000.00 in collateral. This allows the guarantor to enter various terms on which he is willing to guarantee loans in order to increase the chances of matching with lenders and borrowers.

It is necessary for the guarantor to implicitly or explicitly give the loan facilitator authority to enter into a specific guaranty transaction before the loan facilitator can perform this sort of matching. This is shown at step 522 for exemplary purposes, but can be combined with other steps and can occur when the guarantor submits a guaranty offer with guaranty terms at step 514. Step 522 can be an explicit or implicit step that can take place at any point in the process. As long as the necessary steps including the committed guaranty offer at steps 514/522 and the funding of the collateral account have occurred, the loan facilitator matches the guarantor with a lender meeting the specified guaranty terms (not shown). Once the loan facilitator performs this matching and executes a guaranty transaction on behalf of the guarantor, the guarantor receives notification of this transaction and that collateral has been allocated at step 570. The notice of collateral allocation is important to the guarantor because the collateral allocation effectively freezes the collateral such that other guaranties cannot be made using the same collateral.

Once the guaranty transaction occurs and the related loan transaction occurs at step 472 in FIG. 4, the guarantor receives premium payment(s) from the loan facilitator. As the borrower pays back the loan to the loan facilitator in either lump sum payments or periodic payments, the premium is deducted from the interest portion to be paid to the lender before the lender receives its funds. This premium amount is then credited to the guarantor either in the collateral account or transferred to an external account at step 581. The guarantor can receive the premium payment(s) in any form including electronic funds transfers, wire transfers, paper checks, etc. If the premium payments are credited to the collateral account, the guarantor has the option of utilizing these funds as additional collateral to guarantee additional loans, if desired.

The loan facilitator can optionally free up the guarantor's allocated collateral as loan payments are received. This is not necessary but can be requested or required by guarantors in order to maximize the available funds to collateralize guaranty transactions. For example, as a borrower makes a periodic loan payment and reduces the principal of the loan, the guarantor's new collateral can be recalculated by the loan facilitator as the collateral percentage for the new principal amount. This can reallocate a portion of the allocated collateral for a given loan. This amount may not be significant for a single loan but it can be a very significant amount for a guarantor involved in many different loans.

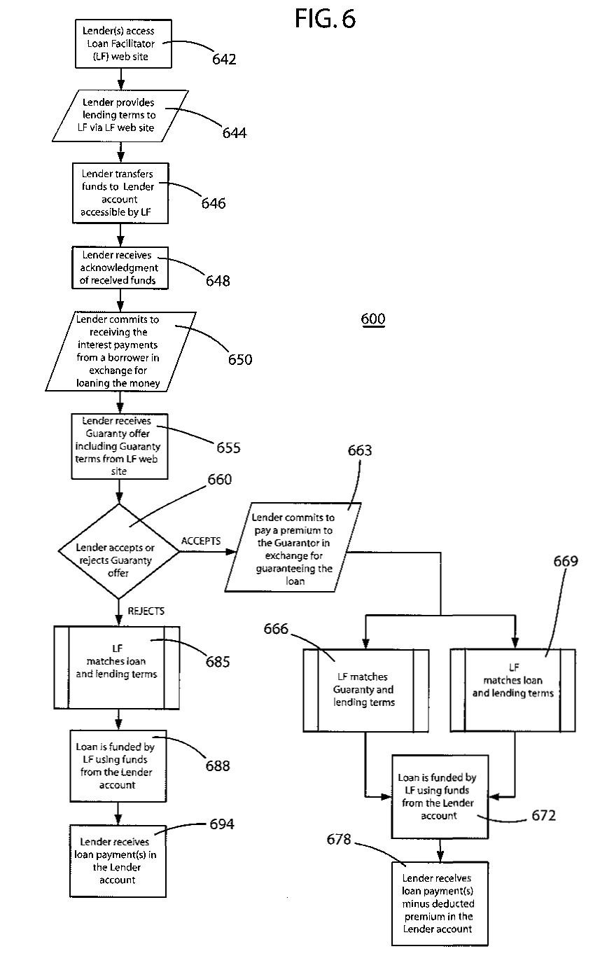

Referring now to FIG. 6, the basic lender process 440 is described from the lender's perspective for completeness. At step 642, a lender accesses the loan facilitator web site. No pre-approval is required for lenders because for each loan transaction, the full amount of the funds are provided from the lender to the borrower and thus credit and financial information are not critical as long as the lender has the required funds. At step 644, the lender creates a lending offers specifying terms on which he is willing to loan money. Such terms include, but are not limited to, interest rate, credit rating, maximum amount, and length of loan. Other terms such as repayment frequency can be entered depending on the exact terms of the loan. At step 646, the lender then transfers funds or makes them available via electronic withdrawal from a third party account for the amount of the loan offer to be made and receives acknowledgement of the transfer or making funds available from the loan facilitator at step 648. Note that the lender can enter multiple loan offers totaling more than the amount of funds transferred or made available. For example, the lender can enter loan offers totaling up to $100,000.00, but only transfer $20,000.00 to his lender account. The loan facilitator only matches loans up to the available funds and thus many offers are never executed because the funds are not available. Alternatively, the lender can instruct the loan facilitator to only match $20,000.00 worth of outstanding loan offers. This allows the lender to enter various terms on which he is willing to loan money in order to increase the chances of matching with borrowers.

It is necessary for the lender to implicitly or explicitly give the loan facilitator authority to enter into a specific loan transaction before the loan facilitator can perform this matching. This is shown at step 650 for exemplary purposes, but can be combined with other steps and can occur when the guarantor submits a guaranty offer with lending terms at step 644. Step 650 can be an explicit or implicit step that can take place at any point in the process. As long as the necessary steps including the committed guaranty offer at steps 644/650 and the funding of the lending account have occurred, the loan facilitator matches the lender with a borrower and, optionally, a guarantor meeting the specified lending terms at steps 666, 669, or 685, as appropriate.

At step 655, the lender receives a guaranty offer from the loan facilitator. The loan facilitator presents typical rates for which a guaranty can be purchased for loans with the terms of the lending offers entered at step 644. The lender can then review the typical terms available and accept or reject the guaranty offer at step 660. If the lender rejects the guaranty offer at step 660, the loan facilitator then attempts to match lending offers with requested loan terms at step 685. If a match occurs, the loan is funded at step 688 by the loan facilitator transferring lender funds to the borrower either through accounts maintained by the loan facilitator or through external accounts. Once the loan is funded, the loan facilitator receives loan payment(s) from the borrower in either periodic payments or lump sum payments and the lender receives the correct portion of the loan payment in the lender account (internal or external) after any fees are subtracted. At this point, the loan facilitator can update the amount of outstanding loan offers based on the principal received.

If the lender chooses to accept a guaranty at step 660, the lender enters his own guaranty terms which he is willing to accept or accept a default set of terms. Generally, the only guaranty term the lender enters is the premium. The remaining terms are typically determined by the loan offers entered. Then the loan facilitator attempts to match guaranty, lending, and loan terms at steps 666 and 669. This is essentially done in parallel although no specific timing is required. However, all three sets of terms generally must be matched for the lender because the lender required a guaranty on this loan. Once the match occurs, the loan is funded at step 672 by transferring funds from the lender account to the borrower. Then the loan facilitator receives loan payments including principal & interest from the borrower in either periodic or lump sum payments. The loan facilitator then distributes the loan payment to the appropriate parties. The loan payments (including principal and interest) minus any loan facilitator fees and the matched guaranty premium is then credited to the lender account at step 678. The guaranty premium is also credited to the guarantor's account at step 581.

In the above description of the preferred embodiments, certain steps have been omitted where the steps are implicit. One example of such an implicit step is that when a loan is funded from the lender account, it is implicit that the balance in the lender account decreases and less funds are available for use in future loan transactions. The omission of a minor step, such as an implicit step, is in no way limiting of the inventive method disclosed herein. Also note that the above illustrative descriptions treat the guarantors, lenders, borrowers, and the loan facilitator as separate parties. It is conceivable that the parties can participate in different types of roles for various transactions. For example, the loan facilitator may act as a guarantor or lender in some transactions. The guarantor may act as a lender in some transactions. The borrower may borrow money in one instance and loan money in another instance.

Thus, while there have been shown, described, and pointed out fundamental novel features of the invention as applied to several embodiments, it can be understood that various omissions, substitutions, and changes in the form and details of the devices illustrated, and in their operation, may be made by those skilled in the art without departing from the spirit and scope of the invention. Features, aspects, and steps in any disclosed embodiment can generally be employed in any other embodiment with equal advantage and is intended within the scope of the invention. It is also to be understood that the drawings are not necessarily drawn to scale, but that they are merely conceptual in nature. The invention is defined solely with regard to the claims appended hereto, and equivalents of the recitations therein.

We claim:

1. In a guaranteed peer-to-peer lending environment, a method for managing loan payments between a borrower and a lender, comprising the steps of:
providing from a server to a first client machine a selection of borrower classes including a guaranteed class;
the server receiving from lenders at respective first client machines respective lender-parameters and respective selected borrower-classes, the lender-parameters including an amount to lend, a term, and a lender-rate;
in the event that the selected borrower-class is the guaranteed class, automatically allocating a portion of the loan payments to a collateral account of a guarantor.

2. The method of claim 1, wherein the borrower classes include a plurality of guaranteed classes, each guaranteed class comprising one or more individuals having a credit rating within a common range.

3. The method of claim 1, wherein the allocated portion corresponds to a premium-rate and wherein the lender-rate plus the premium-rate does not exceed a maximum borrower-rate.

4. The method of claim 1, including the additional steps of:
the server receiving from a plurality of borrowers at respective second client machines personal information sufficient to perform a credit check on each such borrower and respective borrower-parameters including an amount to borrow, a loan term, and a borrower-rate;
assigning each borrower to a borrower class based on a standardized credit rating system using the personal information of each borrower;
comparing certain borrower-parameters of the borrowers against the lender-parameters of the respective lenders;
establishing a loan between a particular lender and a particular borrower in the event that the comparison of the particular lender and the particular borrower identifies that the selected borrower-class is being lower than or equal to the assigned borrower-class, identifies the amount to borrow being lower than or equal to the amount to lend, and determines that the borrower rate is at least equal the lender-rate plus a guarantor premium.

5. The method of claim 4, including the additional step of dividing the amount to borrow into tranches and wherein the comparison of borrower-parameters has the amount to lend exceeding the amount in at least one of the tranches of the particular borrower.

6. The method of claim 4, including the additional steps, before the step of establishing the loan, of accepting funds from the lender and crediting the accepted funds into a lender account of the particular lender.

7. The method of claim 6, including the additional steps, after the step of establishing the loan, of:
transferring funds from the lender account of the particular lender to the particular borrower;
receiving one or more of the loan payments from the particular borrower;
in the event that the particular borrower is in the guaranteed class, crediting a portion of each loan payment to the lender account of the particular lender;
wherein the credited portion together with the guarantor allocated-portion is no more than each received loan payment.

8. The method of claim 1, including the additional step of backing the guaranteed class with assets from an account of the guarantor by:
receiving guaranty terms provided by the guarantor to the server, the guaranty terms including a guarantor premium, a guaranteed-class identifier, and a maximum guaranty amount;
determining collateral amount necessary to guarantee any loan satisfying the guaranty terms based, at least in part, upon the maximum guarantee amount;
accepting funds from the guarantor; and
crediting the accepted funds into the collateral account.

9. The method of claim 8, wherein the guarantor premium is a minimum interest rate.

10. The method of claim 8, including the additional step, after the step of crediting the accepted funds into the collateral account, of selectively including a particular guarantor in a loan and allocating the portion of the loan payments to the particular guarantor.

11. In a guaranteed peer-to-peer lending environment, a method for managing loan payments between a borrower and a lender, comprising the steps of:
providing from a server to a first client machine a selection of borrower classes;
the server receiving from lenders at respective first client machines respective lender-parameters and respective selected borrower-classes, the lender-parameters including an amount to lend, a term, and a lender-rate;
transmitting an offer to the lender at a particular first client machine to guarantee any loan satisfying the lender parameters in exchange for a guarantor premium;
in the event that the lender accepts the offer, automatically allocating a portion of any loan payments to a collateral account of a guarantor.

12. A method for a lender to establish a loan, comprising the steps of:
accessing from a client machine a web site hosted by a server;
providing lending terms from the client machine to the server, the lending terms including an interest rate and a minimum credit rating;
funding a lender account with a dollar amount;
before funding any loan using money in the lender account:
reviewing at the client machine a third-party offer made available through the web site which offers to guarantee any loan satisfying the lending terms; and
committing to pay a premium to the third-party in order to guarantee the loan; and
after funding the loan, receiving at least one loan payment in the lender account.

13. The method of claim 10, wherein the committing step comprises deducting the premium from the lender account.

14. The method of claim 10, wherein the receiving step comprises deducting the premium from one or more loan payments until the premium commitment is satisfied.

15. The method of claim 10, wherein the receiving step comprises the steps of allocating the premium across a total number of periodic loan payments of the loan, and deducting the allocated premium against each periodic loan payment.

16. A method for a guarantor to secure a loan, comprising the steps of:
accessing from a client machine a web site hosted by a server;
submitting guaranty terms from the client machine to the server, the guaranty terms including a premium and a minimum credit rating;
before guaranteeing any loan using money in a collateral account:
examining at the client machine a required collateral to guarantee any loan satisfying the guaranty terms;
posting the required collateral to a collateral account; and
agreeing to receive a premium from a third-party in order to guarantee the loan; and
after guaranteeing the loan, receiving a guaranty premium payment in the collateral account.

17. The method of claim 14 wherein the agreeing step comprises receiving the premium from a loan payment.

18. The method of claim 14, wherein the receiving step comprises periodically receiving the premium against a periodic loan payment until the premium commitment is satisfied.

19. The method of claim 14, wherein the receiving step comprises the steps of allocating the premium across a total number of loan payments of the loan, and receiving the allocated premium against each loan payment.

20. The method of claim 14 wherein the collateral includes one or more chosen from the group consisting of cash, cash equivalents, stocks, bonds, real estate holdings, notes, and mortgages.

21. The method of claim 14, including the additional steps, before accessing from a client machine a web site hosted by a server, of:
submitting detailed financial information to a loan facilitator;
receiving access to a web site hosted by a server; and
reviewing at a client terminal the maximum guaranty limit.
